(19) United States
(12) Patent Application Publication
(10) Pub. No.: US 2022/0050541 A1
(43) Pub. Date: Feb. 17, 2022

(54) TOUCH CONTROL DISPLAY PANEL AND TOUCH CONTROL DISPLAY APPARATUS

(71) Applicant: Wuhan China Star Optoelectronics Semiconductor Display Technology Co., Ltd., Wuhan, Hubei (CN)

(72) Inventor: Xiaoliang FENG, Wuhan, Hubei (CN)

(73) Assignee: Wuhan China Star Optoelectronics Semiconductor Display Technology Co., Ltd., Wuhan, Hubei (CN)

(21) Appl. No.: 17/274,823

(22) PCT Filed: Apr. 10, 2019
(86) PCT No.: PCT/CN2019/081992

§ 371 Date: Mar. 10, 2021

(30) Foreign Application Priority Data
Dec. 14, 2018 (CN) 201811531009.X

(51) Int. Cl. G06F 3/041

(52) U.S. Cl. CPC G06F 3/0412; G06F 2203/04111; G06F 3/04164

(57) ABSTRACT

Provided are a touch control display panel and a touch control display apparatus. The touch control display panel comprises a touch control area and a binding area. The touch control display panel comprises a substrate, and a touch control layer arranged in the touch control area. The touch control layer comprises a touch control pattern layer, an insulating layer and bridging layer. The touch control pattern layer at least comprises two touch control electrode groups, wherein each of the touch control electrode groups at most leads out two touch control wirings, and the touch control wirings are led out from one side, close to the binding area, of the touch control area.

### BACKGROUND

### Field

The present disclosure relates to a technical field of display devices, and more particularly to a touch control display panel and touch control display apparatuses.

### Background

At present, the development trend of touch display industry is developed towards a direction of the narrow bezel, and the narrow bezel design can increase the size of a display area of a touch control display apparatus and bring better visual sense to the user.

For a touch control display apparatus integrated with a touch control function, the bezel is determined by a bezel portion covering a glass panel, a bezel portion (e.g., a peripheral routing region) of a touch control display panel, and a bezel portion (e.g., peripheral circuits and packaging regions) on the touch control display panel. The bezel portion covering the glass panel and the bezel portion on the touch control display panel have sufficient space to achieve a narrow bezel design. The bezel part of the touch control display panel is mainly formed by arranging touch control routing. The limitation of the line widths and the line spacing of the touch control routing causes restrictions of the narrow bezel design of total line widths. On one hand, the bezel portion of the touch control display panel is difficult to have a better narrow bezel effect. On the other hand, since the touch control routing needs to be integrated in a binding area, more wiring arrangement causes the binding area not to be shrunk, thereby further limiting the narrow bezel design of the touch control display panel.

Therefore, there is a need to solve above-mentioned problems of touch control display panels and touch control display apparatuses.

### SUMMARY OF THE DISCLOSURE

The present disclosure provides a touch control display panel and a touch control display apparatus to solve the problems of a low display ratio of the touch control display panel that are caused by the touch control wiring arranged outside a touch control area in the touch control display panel.

In order to solve above-mentioned problems, the present disclosure provides following technical schemes.

According to an embodiment, the present disclosure provides a touch control display panel, wherein the touch control display panel comprises a touch control area and a binding area disposed on a side of the touch control area, the touch control display panel comprising:

a substrate,

a touch control layer disposed on the substrate, wherein the touch control layer is arranged on the touch control area, and the touch control layer comprises:

a touch control pattern layer comprising at least two touch control electrode groups, wherein each of the touch control electrode groups is provided with two touch control wirings;

an insulating layer arranged on the touch control pattern layer;

a bridging layer comprising a bridge unit and the touch control wirings;

wherein the touch control wirings are led out from a side of the touch control area near the binding area.

In an embodiment of the touch control display panel, the touch control pattern layer comprises a first touch control electrode set and a second touch control electrode set that are arranged in a vertically and horizontally interlaced manner;

wherein first touch control electrode set comprises at least two first touch control electrodes, and the second touch control electrode set comprises at least two second touch control electrodes.

In an embodiment of the touch control display panel, adjacent first touch control electrodes are connected through the bridge unit.

In an embodiment of the touch control display panel, the touch electrode group comprises at least two touch control electrodes which are connected with each other;

wherein each of the touch control wirings corresponds to one of touch control electrode groups, and is led out by a touch control electrode of the corresponding touch electrode group.

In an embodiment of the touch control display panel, each of the touch control wirings comprises a first connecting part and a second connecting part which are connected with each other;

wherein the first connecting part is arranged on a surface of the touch control electrode, and the insulating layer is arranged between the second connecting part and the touch control electrode.

In an embodiment of the touch control display panel, the second connecting part is arranged in the middle of the touch control area and is led out from a side of the touch control area near the binding area.

In an embodiment of the touch control display panel, the bridging layer is made of indium oxide zinc.

In an embodiment of the touch control display panel, the bridge unit and the touch control wires are insulated from each other.

In an embodiment of the touch control display panel, the touch control display panel further comprises a metal wiring arranged in the binding area, and the metal wiring is arranged corresponding to the touch control wiring;

wherein the touch control wiring is led out from a side of the touch control area near the binding area and is connected with the metal wiring.

In an embodiment of the touch control display panel, a touch control electrode of the touch control electrode groups is one of a metal grid electrode and an indium zinc oxide electrode.

According to another embodiment, the present disclosure provides a touch control display apparatus, wherein the touch control display apparatus comprises a polarizer and a touch control display panel, and the touch control display panel comprises a touch control area and a binding area disposed on a side of the touch control area, the touch control display panel comprising:

a substrate;

a touch control layer arranged on the substrate, wherein the touch control layer is arranged in the touch control area, and the touch control layer comprises:

a touch control pattern layer comprising two touch control electrode groups, wherein each touch control electrode group is provided with at most two touch control wires;

an insulating layer arranged on the touch control pattern layer;

a bridging layer comprising a bridge unit and the touch control wiring;

wherein the touch control wiring is led out from one side, close to the binding area, of the touch control area.

In an embodiment of the touch control display apparatus, the touch control pattern layer comprises a first touch control electrode set and a second touch control electrode set that are arranged in a vertically and horizontally interlaced manner;

wherein first touch control electrode set comprises at least two first touch control electrodes, and the second touch control electrode set comprises at least two second touch control electrodes.

In an embodiment of the touch control display apparatus, adjacent first touch control electrodes are connected through the bridge unit.

In an embodiment of the touch control display apparatus, the touch electrode group comprises at least two touch control electrodes which are connected with each other;

wherein each of the touch control wirings corresponds to one of touch control electrode groups, and is led out by a touch control electrode of the corresponding touch electrode group.

In an embodiment of the touch control display apparatus, each of the touch control wirings comprises a first connecting part and a second connecting part which are connected with each other;

wherein the first connecting part is arranged on a surface of the touch control electrode, and the insulating layer is arranged between the second connecting part and the touch control electrode.

In an embodiment of the touch control display apparatus, the second connecting part is arranged in the middle of the touch control area and is led out from a side of the touch control area near the binding area.

In an embodiment of the touch control display apparatus, the bridging layer is made of indium oxide zinc.

In an embodiment of the touch control display apparatus, the bridge unit and the touch control wires are insulated from each other.

In an embodiment of the touch control display apparatus, the touch control display panel further comprises a metal wiring arranged in the binding area, and the metal wiring is arranged corresponding to the touch control wiring;

wherein the touch control wiring is led out from a side of the touch control area near the binding area and is connected with the metal wiring.

In an embodiment of the touch control display apparatus, a touch control electrode of the touch control electrode groups is one of a metal grid electrode and an indium zinc oxide electrode.

The advantages of the present disclosure are provided as follows. The present disclosure provides touch control wirings that are arranged inside the touch control area to solve the problems of a low display ratio of the touch control display panel that are caused by the touch control wiring arranged outside a touch control area. The touch control wiring and the bridge unit are arranged on a same layer, thereby simplifying production processes of the touch control display panel and reducing manufacturing cost of the products.

### BRIEF DESCRIPTION OF THE DRAWINGS

The following embodiments refer to the accompanying drawings for exemplifying specific implementable embodiments of the present disclosure in a suitable computing environment. It should be noted that the exemplary described embodiments are configured to describe and understand the present disclosure, but the present disclosure is not limited thereto.

FIG. 1 is a cross-sectional view of a touch control display panel according to a first embodiment of the present disclosure.

FIG. 2 is a cross-sectional view of a touch control display panel according to a second embodiment of the present disclosure.

FIG. 3 is a cross-sectional view of a touch control display panel according to a third embodiment of the present disclosure.

FIG. 4 is a cross-sectional view of a touch control display panel according to a fourth embodiment of the present disclosure.

### DETAILED DESCRIPTION OF THE PREFERRED EMBODIMENTS

The following embodiments refer to the accompanying figures for exemplifying specific implementable embodiments of the present disclosure in a suitable environment. It should be noted that the exemplary described embodiments are configured to describe and understand the present disclosure, but the present disclosure is not limited thereto. Directional terms, such as an upper side, a lower side, a front side, a back side, a left side, a right side, an inner side, an outer side, and a lateral side, mentioned in the present disclosure are only for reference. Therefore, the directional terms are used for describing and understanding rather than limiting the present disclosure. In the figures, units having similar structures are used for the same reference numbers.

The present disclosure provides a touch control display panel and a touch control display apparatus to solve the problems of a low display ratio of the touch control display panel that are caused by the touch control wiring arranged outside a touch control area in the touch control display panel.

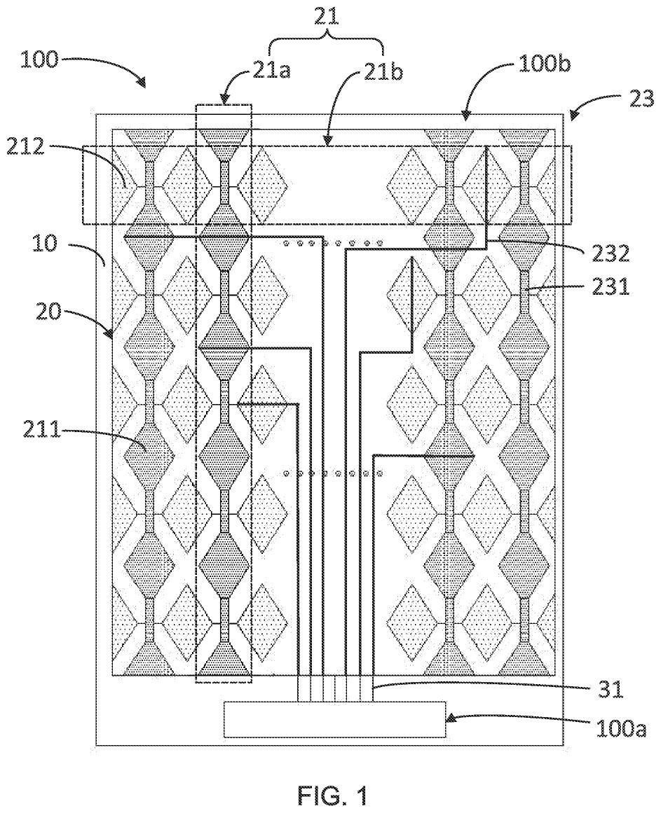

Please refer to FIG. 1. FIG. 1 is a cross-sectional view of a touch control display panel 100 according to a first embodiment of the present disclosure.

According to an embodiment of the present disclosure, a touch control display panel includes a touch control area 100b and a binding area 100a disposed on a side of the touch control area 100b.

Touch control electrodes used for sensing touch signals are arranged in the touch control area 100b, and the binding area 100a is a connecting position of a touch control wiring 232 connected with the touch control electrode, such that the touch control wiring 232 and other metal wiring 31 are connected with a flexible circuit board.

The flexible circuit board is provided with a touch control integrated circuit (IC) and a driving IC.

The touch control display panel 100 includes a substrate 10 and a touch control layer disposed on the substrate 10.

In one embodiment, material of the substrate 10 is glass or organic polymer.

The touch control layer is arranged in the touch control area 100b.

The touch control layer includes a touch control pattern layer 21, an insulating layer 22, and a bridging layer 23.

The touch control pattern layer 21 includes two touch control electrode groups, and each of touch control electrode groups is provided with touch control wires 232, e.g., at most two touch control wirings 232.

In a touch control state, a touch electrode group transmits touch signals of the touch control electrodes via the touch control wiring 232 the metal wiring 31 of the binding area 100a, and the touch signals is then transmitted from the metal wiring 31 to the touch control IC on the flexible circuit board.

In one embodiment, the touch control pattern layer 21 includes a first touch control electrode set 21a and a second touch control electrode set 21b.

The first touch control electrode set 21a includes at least two first touch control electrodes 211, and the second touch control electrode set 21b includes at least two second touch control electrodes 212.

In one embodiment, a touch control electrode 213 is one of a metal grid electrode and an indium zinc oxide electrode, as shown in FIG. 3 and FIG. 4, where a first touch control electrode or a second touch control electrode can be regarded as a touch control electrode 213.

In one embodiment, the first touch control electrode 211 is a transmitting electrode, and the second touch control electrode 212 is a receiving electrode.

The insulating layer 22 is disposed between the bridging layer 23 and the touch control pattern layer 21.

In one embodiment, the insulating layer 22 is made of at least one of silicon nitride, silicon oxide, or silicon oxynitride.

The bridging layer 23 includes a bridge unit 231 and a touch control wiring 232. The bridge unit 231 and the touch control wiring 232 are arranged on a same layer, such that the bridge unit 231 and the touch control wiring 232 are formed in a same manufacturing process, thereby simplifying production processes of the touch control display panel 100.

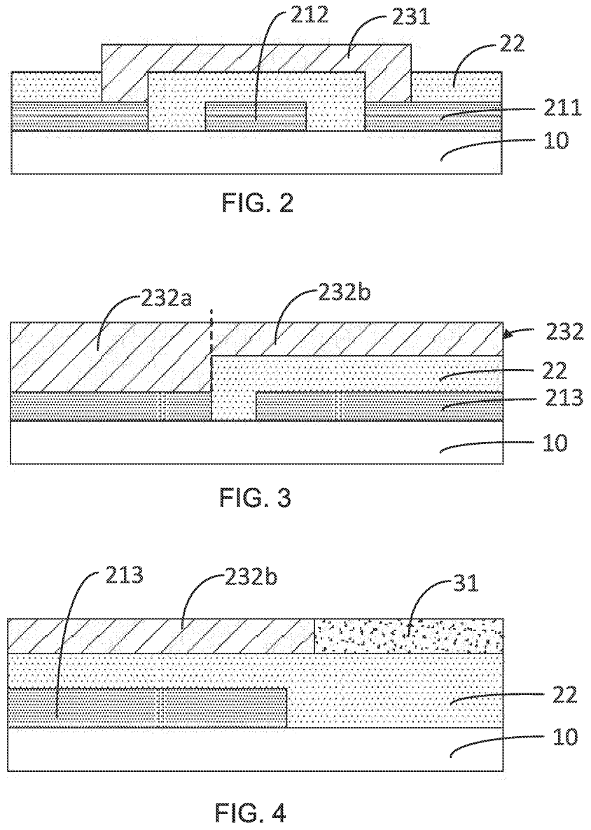

Please refer to FIG. 2. FIG. 2 is a cross-sectional view of a touch control display panel 100 according to a second embodiment of the present disclosure.

In an embodiment, adjacent first touch control electrodes 211 are connected through the bridge unit 231.

In an embodiment, a through hole structure is arranged in the insulating layer 22 for connecting the bridge unit 231 with the first touch control electrode 211.

The touch control wiring 232 is led out from a side of the touch control area 100b near the binding area 100a.

The touch control wiring 232 is led out from the side of the touch control area 100b near the binding area 100a, such that the touch control wiring 232 is arranged in the touch control area 100b. The touch control wiring 232 is prevented from occupying a large space outside the touch control area 100b, such that the design of the narrow bezel of the touch control display panel 100 is realized.

In an embodiment, in order to avoid the fact that the touch control wiring 232 is arranged in the touch control area 100b, the light emitting of the product is influenced, the material of the touch control wiring 232 includes indium zinc oxide, where indium zinc oxide is a conductive material of transparent semiconductor.

In an embodiment, the bridging layer 23 is made of indium zinc oxide.

In an embodiment, adjacent touch control wirings 232 are insulated from each other.

In an embodiment, the touch electrode group includes at least two mutually connected touch control electrodes 213.

Each of the touch control wirings 232 corresponds to one of touch control electrode groups, and is led out by a touch control electrode 213 of the corresponding touch electrode group.

Referring to FIG. 3, FIG. 3 is a cross-sectional view of a touch control display panel 100 according to a third embodiment of the present disclosure.

In an embodiment, a touch control wiring 232 includes a first connecting part 232a and a second connecting part 232b which are connected with each other.

The first connecting part 232a is arranged on the surface of the touch control electrode 213, and the insulating layer 22 is arranged between the second connecting part 232b and the touch control electrode 213.

In an embodiment, the first connecting part 232a is arranged on the touch control electrode 213, and is arranged along a position of the longest straight line of the touch control wirings 232. Because the first connecting part 232a is in contact with the corresponding touch control electrode 213 as much as possible, such that the touch control wirings 232 can be prevented from being broken.

In an embodiment, in order to facilitate arrangement of the touch control wiring 232, the second connecting part 232b is arranged in the middle of the touch control area 100b and is led out from a side of the touch control area 100b near the binding area 100a. Moreover, such a design can also avoid the problem that the area of the bezel is too large when the touch control wirings 232 is led out from the touch control area 100b.

In an embodiment, the bridge unit 231 is used for connecting the touch control electrodes 213 in the touch electrode group, and the touch control wiring 232 is used for connecting the touch control electrodes 213 with the flexible circuit board. Therefore, the touch control wiring 232 and the bridge unit 231 are insulated from each other. When touch control wirings 232 pass through a position of the bridge unit 231, a winding arrangement of the touch control wirings 232 is used to avoid the bridge unit 231.

Please refer to FIG. 4. FIG. 4 is a cross-sectional view of a touch control display panel 100 according to a fourth embodiment of the present disclosure.

In an embodiment, the touch control display panel 100 further includes a metal wiring 31 arranged in the binding area 100a, and the metal wiring 31 is arranged corresponding to the touch control wiring 232.

The touch control wiring 232 is led out from a side of the touch control area 100b near the binding area 100a and is connected with the metal wiring 31.

In an embodiment, the metal wiring 31 partially covers the touch control wiring 232 to avoid poor contact between the metal wiring 31 and the touch control wiring 232.

In an embodiment, the touch control display panel 100 further includes a binding pad arranged between the metal wiring 31 and the flexible circuit board, and is used for fixing the connection between the metal wiring 31 and the flexible circuit board.

According to another embodiment of the present disclosure, the present disclosure further provides a touch control display panel 100 including a polarizer and a touch control display panel 100.

The touch control display panel 100 includes a touch control area 100b and a binding area 100a located on one side of the touch control area 100b.

The touch control display panel includes:

a substrate 10;

a touch control layer disposed on the substrate 10, where the touch control layer is arranged on the touch control area 100b, and the touch control layer includes:

a touch control pattern layer 21 including at least two touch control electrode groups, wherein each of the touch control electrode groups is provided with touch control wires 232, e.g., at most two touch control wirings 232;

an insulating layer 22 arranged on the touch control pattern layer 21;

a bridging layer 23 including a bridge unit 231 and the touch control wiring 232;

where a touch control wiring 232 is led out from a side of the touch control area 100b near the binding area 100a.

In an embodiment, the touch control pattern layer 21 includes a first touch control electrode set 21a and a second touch control electrode set 21b that are arranged in a vertically and horizontally interlaced manner.

The first touch control electrode set 21a includes at least two first touch control electrodes 211, and the second touch control electrode set 21b includes at least two second touch control electrodes 212.

In an embodiment, adjacent first touch control electrodes 211 are connected through the bridge unit 231.

In an embodiment, the touch electrode group includes at least two mutually connected touch control electrodes.

Each of the touch control wirings 232 corresponds to one of touch control electrode groups, and is led out by a touch control electrode 213 of the corresponding touch electrode group.

In an embodiment, a touch control wiring 232 includes a first connecting part 232a and a second connecting part 232b which are connected with each other.

The first connecting part 232a is arranged on the surface of the touch control electrode 213, and the insulating layer 22 is arranged between the second connecting part 232b and the touch control electrode 213.

In an embodiment, the second connecting part 232b is arranged in the middle of the touch control area 100b and is led out from a side of the touch control area 100b near the binding area 100a.

In an embodiment, the bridging layer 23 is made of indium oxide zinc.

In an embodiment, the bridge unit 231 and the touch control wiring 232 are insulated from each other.

In an embodiment, the touch control display panel 100 further includes a metal wiring 31 arranged in the binding area 100a, and the metal wiring 31 is arranged corresponding to the touch control wiring 232.

The touch control wiring 232 is led out from a side of the touch control area 100b near the binding area 100a and is connected with the metal wiring 31.

The advantages of the present disclosure are provided as follows. The present disclosure provides touch control wirings that are arranged inside the touch control area to solve the problems of a low display ratio of the touch control display panel that are caused by the touch control wiring arranged outside a touch control area. The touch control wiring and the bridge unit are arranged on a same layer, thereby simplifying production processes of the touch control display panel and reducing manufacturing cost of the products.

As is understood by a person skilled in the art, the foregoing preferred embodiments of the present disclosure are illustrative rather than limiting of the present disclosure. It is intended that they cover various modifications and similar arrangements be included within the spirit and scope of the present disclosure, the scope of which should be accorded the broadest interpretation so as to encompass all such modifications and similar structures.

What is claimed is:

1. A touch control display panel, wherein the touch control display panel comprises a touch control area and a binding area disposed on a side of the touch control area, the touch control display panel comprising:
a substrate,
a touch control layer disposed on the substrate, wherein the touch control layer is arranged on the touch control area, and the touch control layer comprises:
a touch control pattern layer comprising at least two touch control electrode groups, wherein each of the touch control electrode groups is provided with two touch control wirings;
an insulating layer arranged on the touch control pattern layer;
a bridging layer comprising a bridge unit and the touch control wirings;
wherein the touch control wirings are led out from a side of the touch control area near the binding area.

2. The touch control display panel according to claim 1, wherein the touch control pattern layer comprises a first touch control electrode set and a second touch control electrode set that are arranged in a vertically and horizontally interlaced manner;
wherein first touch control electrode set comprises at least two first touch control electrodes, and the second touch control electrode set comprises at least two second touch control electrodes.

3. The touch control display panel according to claim 2, wherein adjacent first touch control electrodes are connected through the bridge unit.

4. The touch control display panel according to claim 1, wherein the touch electrode group comprises at least two touch control electrodes which are connected with each other;
wherein each of the touch control wirings corresponds to one of touch control electrode groups, and is led out by a touch control electrode of the corresponding touch electrode group.

5. The touch control display panel according to claim 4, wherein each of the touch control wirings comprises a first connecting part and a second connecting part which are connected with each other;
wherein the first connecting part is arranged on a surface of the touch control electrode, and the insulating layer is arranged between the second connecting part and the touch control electrode.

6. The touch control display panel according to claim 5, wherein the second connecting part is arranged in the middle of the touch control area and is led out from a side of the touch control area near the binding area.

7. The touch control display panel according to claim 1, wherein the bridging layer is made of indium oxide zinc.

8. The touch control display panel according to claim 1, wherein the bridge unit and the touch control wires are insulated from each other.

9. The touch control display panel according to claim 1, wherein the touch control display panel further comprises a metal wiring arranged in the binding area, and the metal wiring is arranged corresponding to the touch control wiring;
wherein the touch control wiring is led out from a side of the touch control area near the binding area and is connected with the metal wiring.

10. The touch control display panel according to claim 1, wherein a touch control electrode of the touch control electrode groups is one of a metal grid electrode and an indium zinc oxide electrode.

11. A touch control display apparatus, wherein the touch control display apparatus comprises a polarizer and a touch control display panel, and the touch control display panel comprises a touch control area and a binding area disposed on a side of the touch control area, the touch control display panel comprising:
a substrate;
a touch control layer arranged on the substrate, wherein the touch control layer is arranged in the touch control area, and the touch control layer comprises:
a touch control pattern layer comprising two touch control electrode groups, wherein each touch control electrode group is provided with at most two touch control wires;
an insulating layer arranged on the touch control pattern layer;
a bridging layer comprising a bridge unit and the touch control wiring;
wherein the touch control wiring is led out from one side, close to the binding area, of the touch control area.

12. The touch control display apparatus according to claim 11, wherein the touch control pattern layer comprises a first touch control electrode set and a second touch control electrode set that are arranged in a vertically and horizontally interlaced manner;
wherein first touch control electrode set comprises at least two first touch control electrodes, and the second touch control electrode set comprises at least two second touch control electrodes.

13. The touch control display apparatus according to claim 12, wherein adjacent first touch control electrodes are connected through the bridge unit.

14. The touch control display apparatus according to claim 11, wherein the touch electrode group comprises at least two touch control electrodes which are connected with each other;
wherein each of the touch control wirings corresponds to one of touch control electrode groups, and is led out by a touch control electrode of the corresponding touch electrode group.

15. The touch control display apparatus according to claim 14, wherein each of the touch control wirings comprises a first connecting part and a second connecting part which are connected with each other;
wherein the first connecting part is arranged on a surface of the touch control electrode, and the insulating layer is arranged between the second connecting part and the touch control electrode.

16. The touch control display apparatus according to claim 15, wherein the second connecting part is arranged in the middle of the touch control area and is led out from a side of the touch control area near the binding area.

17. The touch control display apparatus according to claim 11, wherein the bridging layer is made of indium oxide zinc.

18. The touch control display apparatus according to claim 11, wherein the bridge unit and the touch control wires are insulated from each other.

19. The touch control display apparatus according to claim 11, wherein the touch control display panel further comprises a metal wiring arranged in the binding area, and the metal wiring is arranged corresponding to the touch control wiring;
wherein the touch control wiring is led out from a side of the touch control area near the binding area and is connected with the metal wiring.

20. The touch control display apparatus according to claim 11, wherein a touch control electrode of the touch control electrode groups is one of a metal grid electrode and an indium zinc oxide electrode.
